(19) United States
(12) Patent Application Publication
(10) Pub. No.: US 2003/0158848 A1
(43) Pub. Date: Aug. 21, 2003

(54) Divorce document generating and calculating system

(76) Inventor: Randolph L. Finney, Seattle, WA (US)

Correspondence Address: Lawrence D. Graham, Esq., BLACK LOWE & GRAHAM PLLC, 816 Second Avenue, Seattle, WA, 98104, US

(21) Appl. No.: 10/163,548

(22) Filed: Jun. 5, 2002

Related U.S. Application Data
(60) Provisional application No. 60/357,556, filed on Feb. 15, 2002.

(51) Int. Cl. G06F 17/30

(52) U.S. Cl. 707/10

(57) ABSTRACT

A system and method for generating divorce proceedings paperwork. The system includes a server computer system and a user computer system coupled to a network. The server computer system includes a memory that stores location-based divorce proceeding rules, and a processor with a graphical user interface component. The user computer system includes a user interface component coupled to a processing component. The user interface component presents the graphical user interfaces generated by the graphical user interface component and receives responses to the presented graphical user interfaces. The responses include a selection for the location for the divorce proceedings. The received responses are sent to the server computer system. The graphical user interface component generates graphical user interfaces based on at least one of the location selection or other received responses. The processor automatically generates completed divorce documents based on the received responses.

### PRIORITY CLAIM

This application claims priority from a Provisional Application filed Feb. 15, 2002, Serial No. 60/357,556, Attorney Reference No. EMIT-1-1001.

### FIELD OF THE INVENTION

This invention relates generally to document generating systems and methods, and, more specifically, to network-based document generating systems over a public data network.

### BACKGROUND OF THE INVENTION

In many legal proceedings the major costs are associated with the time and expertise required to generate the required paperwork. The time and expertise are often required even when the legal proceeding itself is essentially a formality. For example, in an uncontested divorce proceeding, there are a number of documents that must be prepared and filed. The act of completing the proper documents is a tedious one that requires some experience in reading and understanding their content and format. Because the paperwork can be confusing and time consuming, those filing for divorce often turn to attorneys to assist them.

Presently there are a number of sources of blank forms and document templates that are useful for legal proceedings such as divorces. While these tools can be helpful in some instances, even completing the blank forms can be daunting in many cases. Therefore, there exists a need to aid a layperson in the process of filling out legal paperwork, especially divorce documents.

### SUMMARY OF THE INVENTION

The present invention comprises a system and method for automatically generating divorce proceedings paperwork. The system includes a server computer system and a user computer system coupled to a network. The server computer system includes a memory that stores location-based divorce proceeding rules, a processor, and a graphical user interface component. The user computer system includes a user interface component coupled to a processing component. The user interface component presents the graphical user interfaces generated by the graphical user interface component and receives responses to the presented graphical user interfaces. The responses include a selection for the location of the divorce proceedings. The received responses are sent to the server computer system. The graphical user interface component generates graphical user interfaces based on at least one of the location selection or other received responses. The processor automatically generates completed divorce documents based on the received responses.

In accordance with further aspects of the invention, the processor automatically calculates child support payments based on the responses.

In accordance with other aspects of the invention, the presented graphical user interfaces comprise one or more questions, brief explanations of the questions, and a hyperlink to the legal statute or other authority related to the questions.

In accordance with still further aspects of the invention, the processor automatically generates completed divorce documents based on the information provided by the user and the appropriate geographical location of the court or other governing body.

In accordance with yet other aspects of the invention, spousal and child support are also automatically generated.

In accordance with still another aspect of the invention, the user computer system is configured to retrieve the generated documents over the network.

In accordance with additional aspects of the invention, the processor generates instructions for reviewing and filing the generated documents.

As will be readily appreciated from the foregoing summary, the invention provides a system and method for reducing the time and cost associated with divorce proceedings.

### BRIEF DESCRIPTION OF THE DRAWINGS

The preferred and alternative embodiments of the present invention are described in detail below with reference to the following drawings.

FIG. 1 is a system diagram of the present invention;

FIG. 2 is a flow diagram of the present invention; and

FIGS. 3-6A and 6B are screen displays of an example network based graphical user interface formed in accordance with the present invention for performing the process shown in FIG. 2.

### DETAILED DESCRIPTION OF THE PREFERRED EMBODIMENT

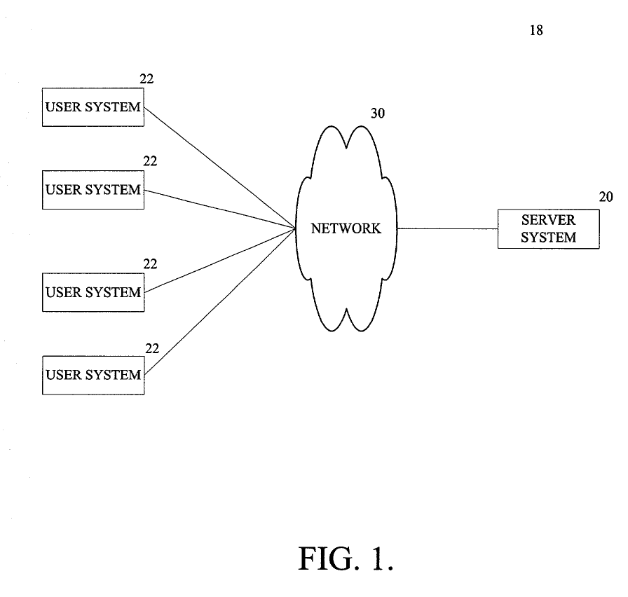

As shown in FIG. 1, the present invention is an automatic divorce document generating and calculating system 18. The system 18 includes a plurality of user systems 22 and a server system 20 in communication over a public or private network 30, such as the Internet.

The server system 20 generates interactive webpages that guide a user at a user system 22 through a questioning session designed to gather the information necessary to complete the divorce proceeding paperwork. Once all the questions have been answered by a user at a user system 22, the server system 20 automatically generates the necessary court documents and calculates child support and alimony based upon the answers the user supplied in response to questions included in the interactive webpages. An application program executed by the server system 20 generates the interactive webpages based on previously entered information regarding laws in a particular state, county, or city; child support and alimony payment algorithms for those state, counties, or cities; personal tax and financial information, and case law information.

The questioning session includes a plurality of questions that are stored in memory at the server system 20. The questions are stored in a tree-like structure. In the tree-like structure, the questions occupy nodes that are linked to one or more other nodes. Sometimes the link between nodes is based on the answer to the question at one of the nodes. For example, if a question at node N is “Are there any children involved?” and the answer is yes, the questions in a child questionnaire branch of nodes in the tree-like structure are presented in order. The last node in the child questionnaire branch of nodes is in one example linked to the same node that node N is linked to if the answer to the node N question is no.

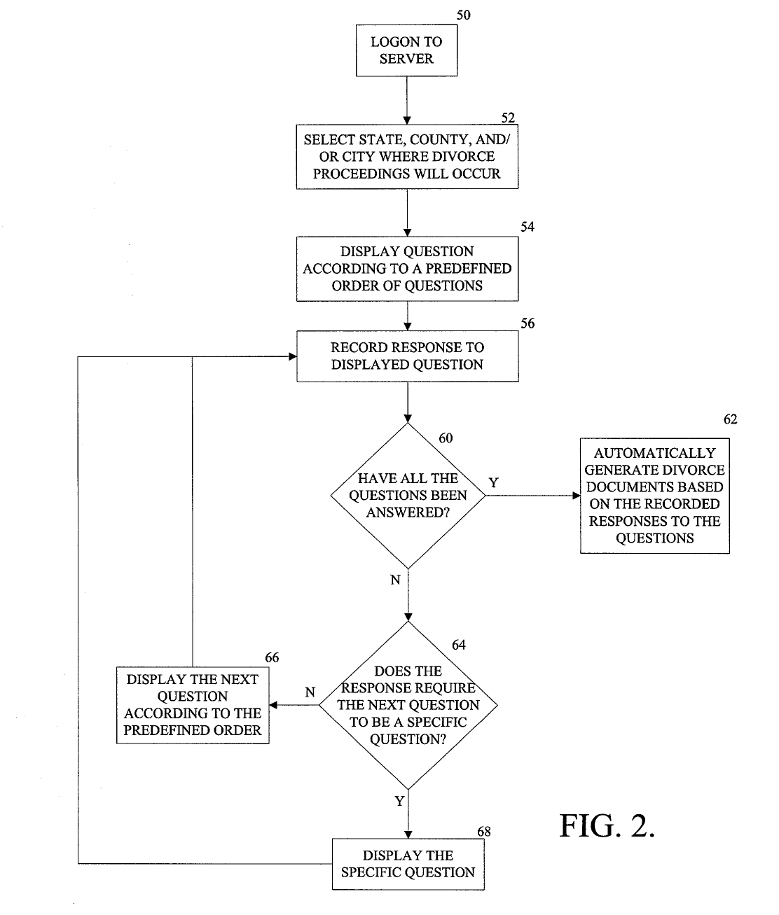

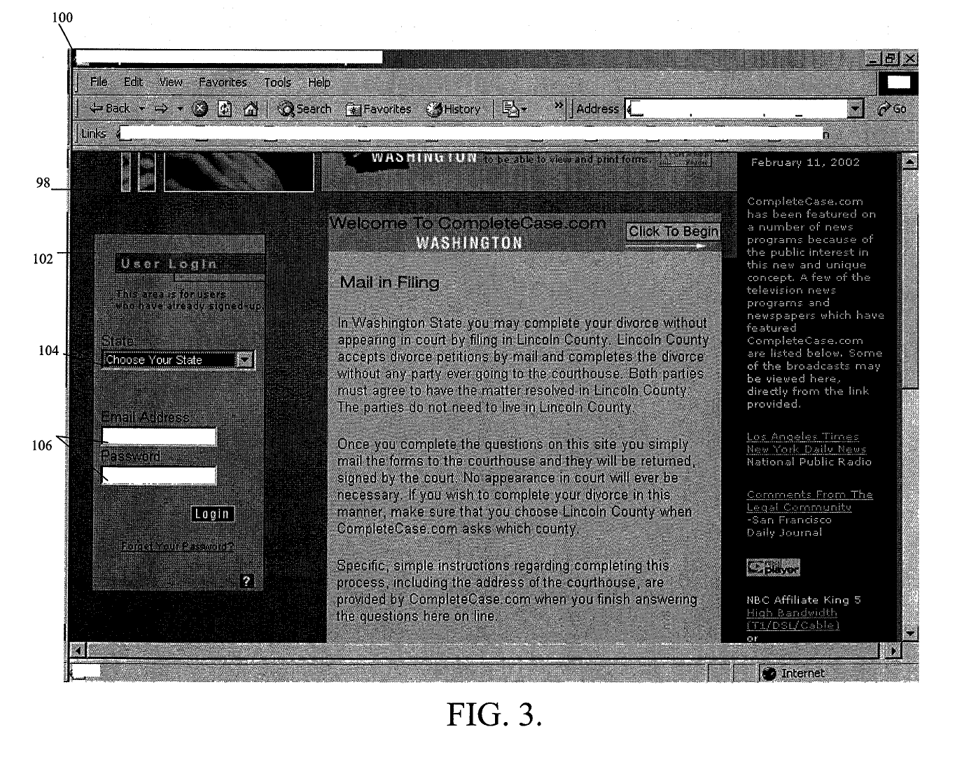

FIG. 2 illustrates a flow diagram of a preferred process performed by the system 18 shown in FIG. 1. First, at block 50, a user at a user system 22 logs onto the server system 20 over the network 30. The server system 20 requires a secure password before a user can interact with interactive webpages generated by an application program executed by the server system 20. Next, at block 52, the user selects the state where divorce proceedings are to occur. Then, at block 54, the application program retrieves and displays a question according to a predefined order of questions that is based on information required for the selected state. The question is displayed on interactive webpages, examples of which are shown in FIGS. 3-6 and described in more detail below. At block 56, a user using the user interface at a corresponding user system 22 answers the displayed question. At block 56, the user's answer to the displayed question is recorded for possible later use in document generation. At decision block 60, the process determines whether all the questions have been answered. If it is determined that all the questions have been answered, the server system 20 automatically generates the required divorce documents for the selected state, county, or city based on the recorded responses to the questions and prestored algorithms for performing various calculations, such as child support, child custody or parenting plans, and alimony.

The prestored algorithms for calculating child support and alimony payments are government sanctioned algorithms or algorithms that are presently being used manually. The prestored algorithms that calculate alimony or child support payments are based upon appropriate statutory and other legal authority, as well as the tax and financial information of both parties of the divorce (for example, it properly accounts for tax related deductions). Because the server system 20 stores the algorithms and the application program, updates and changes to either can be easily performed.

If it is determined at decision block 60 that not all the questions have been answered, the process determines if the recently recorded response requires that the next question be a specific follow-up question. For example, if the question is “Do you have children?” and the answer to that question is yes, the next question in the session is a specific follow-up question to a divorce proceeding where children are involved. Thus, the follow-up questions may inquire, for example, as to the number of children, their ages, tax exemption claiming, and others. If it is determined at decision block 64 that the response does not require a specific follow-up question, the process proceeds to the next question according to a predefined base question sequence, see block 66. After block 66, the process returns to block 56, allowing the user to respond to the question and the system to record responses to questions. If at decision block 64 there does exist a specific question related to the response, the specific question is displayed to the user, see block 68. After block 68, the process returns to block 56.

The specific questions asked are designed to gather information required to prepare various documents as required by the applicable court. Thus, for example, the system will ask questions sufficient to obtain information to prepare a typical petition for dissolution marriage that may include the date and location of the marriage, names and ages of children, property owned, debts and liabilities, whether spousal maintenance is required, pregnancy status, and a desired parenting plan having any bases for restrictions as well as residential scheduling, decision making, and other components.

FIG. 3 illustrates a log-in interactive webpage 98 generated by the application program and presented in a window 100 on a display device of the user system 22. The log-in interactive webpage 98 includes a log-in area 102 that includes a state selection pull-down menu 104 and identification and password log-in area 106. Using an input device, the user selects the state in which to file for divorce from the pull-down menu 104. Though the user can independently select a filing location, the system also suggests one or more locations that may be preferred by the user. For example, at the webpage 98 at which the user is to select a filing location, the system presents one or more locations that may be desirable because filing can be accomplished by mail, filing fees are low, or other attributes.

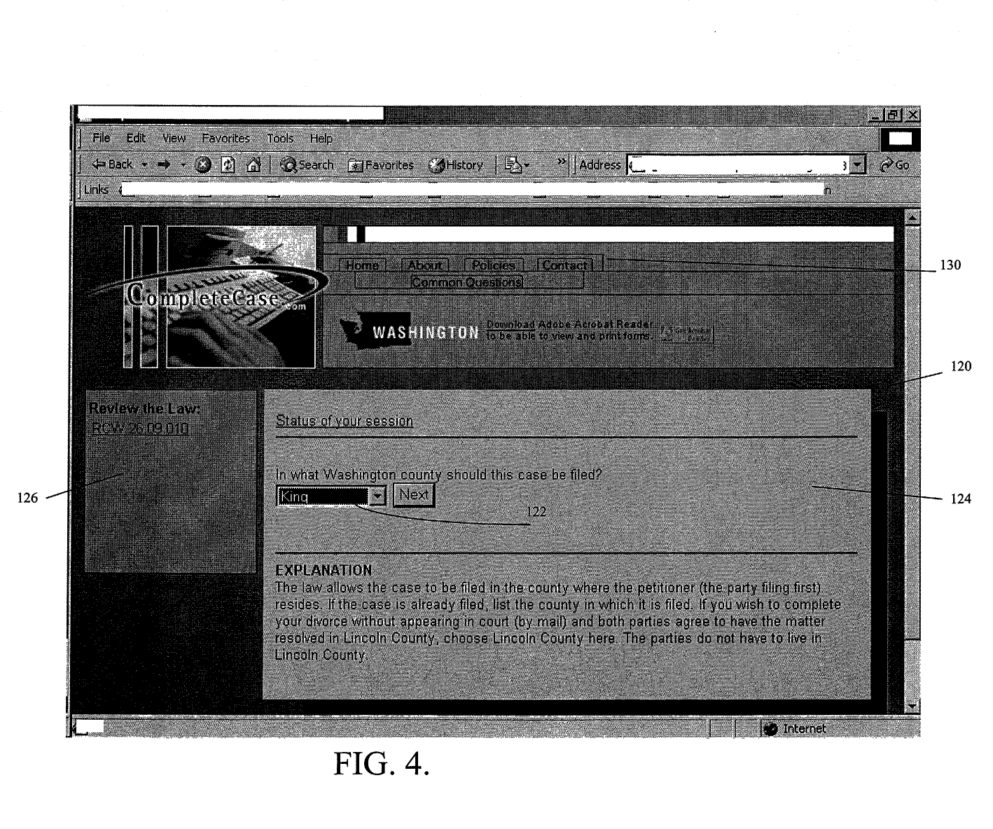

FIG. 4 illustrates a county selection window 120 that includes a county selection pull-down menu 122, similar to the state pull-down menu 104. Some or all of the following interaction areas appear in most or all of the interactive webpages generated by the application program: a question area 124, a law review area 126, and a website button area 130. The question area 124 displays each question, preferably one at a time with an explanation paragraph accompanying and associated with the displayed question. The question area 124 includes hyperlink text to a webpage that indicates the status of the present user session. Displayed adjacent to the question area 124 is the law review area 126. The law review area 126 includes hyperlinks to the specific legal recitations that are associated with the question or questions displayed in the question area 124. The website button area 130 includes various buttons that allow a user to ask or view common questions about the system and how it works, find out contact information, review policy information of the entity operating the server system 20, review general information about the website, and to jump to the initial page of the website.

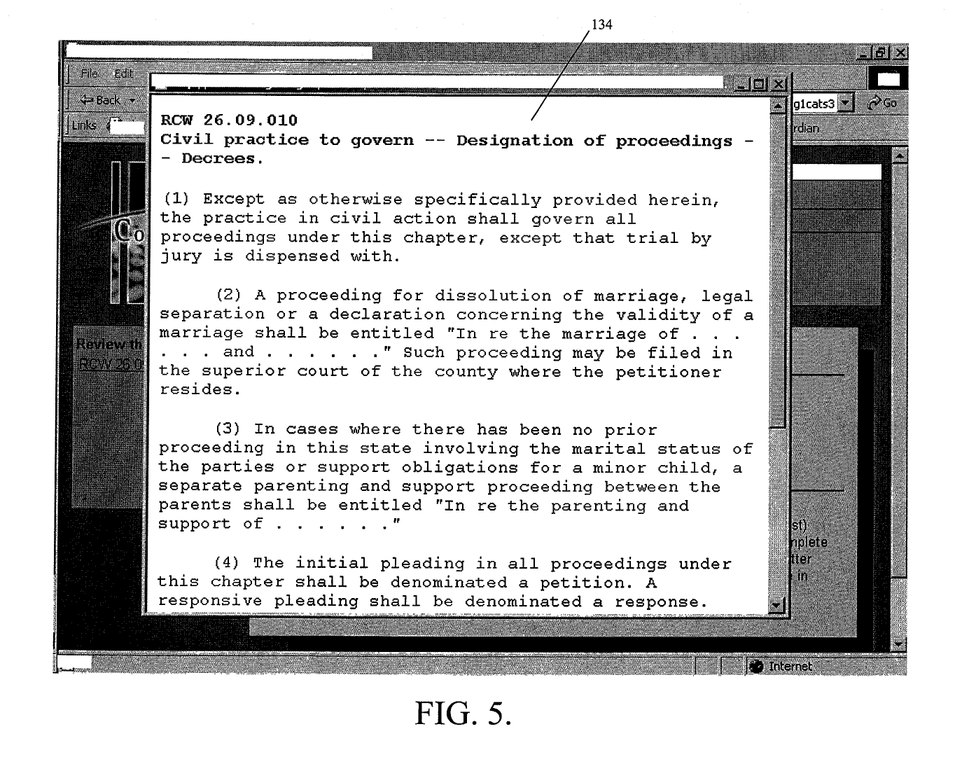

FIG. 5 illustrates a law review window 134 that is retrieved and displayed upon selection of an associated hyperlink text in the law review section 126. The information displayed in window 34 is a selection of the law that relates to the question presently displayed in the question area 124. Although the preferred hyperlink is a textual reference to a statute or other legal authority, the hyperlinks may alternatively be graphical.

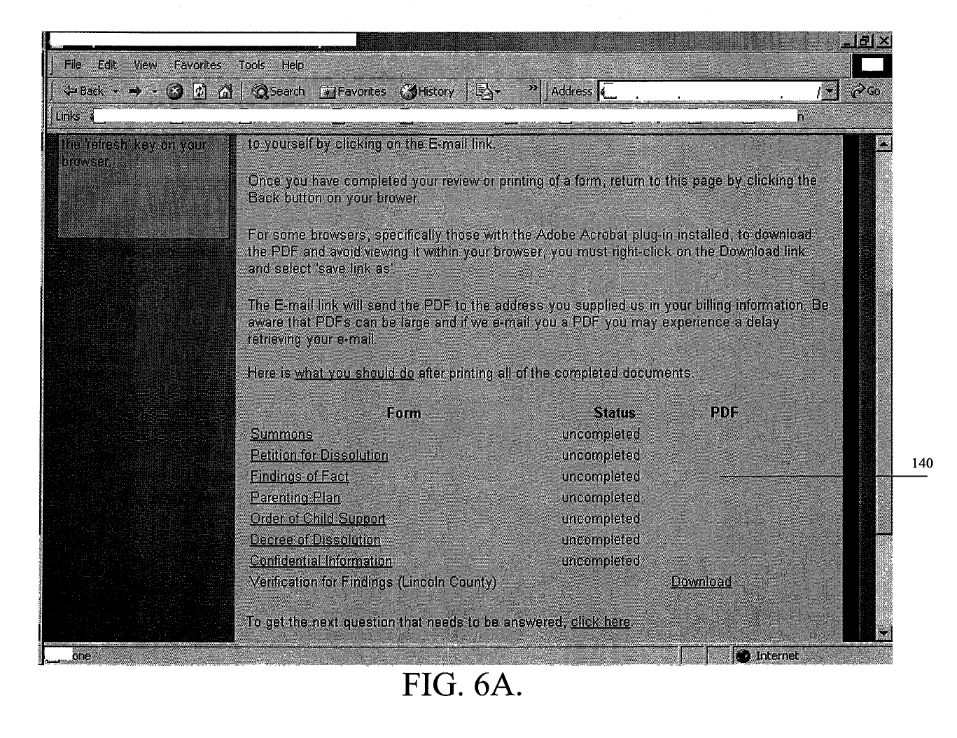

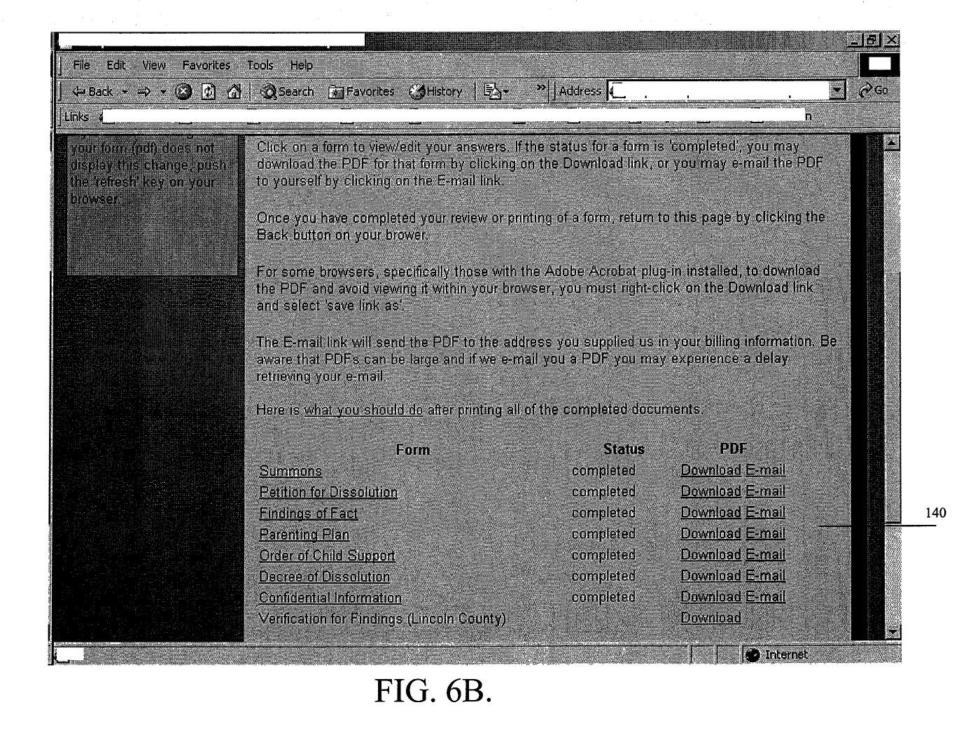

FIGS. 6A and B illustrate a status page that is retrieved and displayed upon selection of the status hyperlink included in the question area 124. The status window includes a status information area 140 that presents the completion status of various legal documents associated with the present session. After a document has been automatically generated upon question session completion or upon completion of the questions that are required for completing the document, the status area 14 presents hyperlinks that allow a user to download or e-mail a generated legal document. Selection of the download hyperlink allows for direct downloading of the legal document in a document format, such PDF or other formats, to the user system 22. Selection of the e-mail hyperlink allows for e-mail delivery of the created legal documents to a destination of choice.

In the particular example of FIG. 6A, the page illustrates the status of all the divorce documents for a user that has not answered enough questions to complete even one of the documents. FIG. 6B, on the other hand, illustrates the status of legal documents as it relates to a user that has completed all the questions presented to the user. The documents that are automatically generated by the present invention include but are not limited to a summons, a petition for dissolution, findings of fact, parenting plan, order of child support, decree of dissolution, confidential information, verification of findings, and a child support schedule.

Also stored at the server system 20 are document filing or court procedure rules or guidelines for the place they designated for their divorce proceedings. The document filing or court procedure rules or guidelines are viewable or printable at a user system 22 at the end of a session, or upon request. The guidelines provide instructions for the user related to completing and filing the forms after they have been downloaded. For example, the instructions explain who must sign the forms, whether they must be served upon a spouse, where to mail or send them, the appropriate filing fee that must be submitted, whether notarization is required, and when and where the user must appear in court (if applicable). Along with the guidelines, the system provides a checklist of many of the above items for review by the user before filing the papers with the court.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A computer based method for generating divorce proceedings paperwork, the method comprising:
displaying questions to a user relating to the divorce proceedings;
recording responses to each of the displayed questions; and
generating completed divorce documents based on the recorded responses to the questions.

2. The method of claim 1, wherein the displayed questions are displayed on a display associated with a microprocessor-based device configured for communication over a computer network, and further comprising the step of receiving the displayed questions from a remote computer over the computer network.

3. The method of claim 2, further comprising the step of indicating a location of the divorce proceedings.

4. The method of claim 2, further comprising calculating child support payments based on the recorded responses to displayed questions.

5. The method of claim 2, further comprising displaying a brief explanation of each question.

6. The method of claim 2, further comprising displaying the law that relates to the displayed question.

7. The method of claim 2, wherein the step of generating is further based on statutory or common law authority.

8. The method of claim 2, further comprising downloading the generated documents to the microprocessor-based device over the computer network.

9. A network based system for generating divorce proceedings paperwork, the system comprising:
a server computer system coupled to a network and accessible by a user computer over the network, the server computer system comprising:
a memory for storing divorce proceeding rules and a graphical user interface component; and
a processor;
wherein the graphical user interface component is operable by the processor to generate graphical user interfaces that solicit from the user computer information related to a divorce proceeding, including a location of the divorce proceeding; and
further wherein the processor generates completed divorce documents based on the information received from the user computer.

10. The system of claim 9, wherein the processor further calculates child support payments based on the responses.

11. The system of claim 9, wherein the graphical user interfaces comprise at least one question and a brief explanation of the at least one question.

12. The system of claim 9, wherein the graphical user interface comprises at least one question and a legal statute associated with the at least one question.

13. The system of claim 9, wherein the processor generates completed divorce documents further based on statutory or common law authority.

14. The system of claim 9, wherein the user computer system is configured to receive the generated documents over the network.

15. The system of claim 9, wherein the information received from the user computer comprises a location of the divorce proceedings.

16. A computer program product for performing the method of claim 1.

17. A network based method for generating divorce proceedings paperwork, the method comprising:
selecting a location for the divorce proceedings;
displaying questions to a user relating to the divorce proceedings and the selected location;
recording responses to each of the displayed questions;
generating completed divorce documents based on the recorded responses to the questions;
calculating child support payments based on the recorded responses to displayed questions;
displaying law that relates to the displayed question; and
downloading the generated documents to a user system over a public data network.

18. A computer program product for performing the method of claim 17.
